(19) United States
(12) Patent Application Publication
(10) Pub. No.: US 2009/0021162 A1
(43) Pub. Date: Jan. 22, 2009

(54) Emissive Movie Theater Display

(76) Inventors: Richard C. Cope, Duluth, GA (US); Aris K. Silzars, Sammamish, WA (US)

Correspondence Address: SUTHERLAND ASBILL & BRENNAN LLP, 999 PEACHTREE STREET, N.E., ATLANTA, GA, 30309, US

(21) Appl. No.: 11/834,189

(22) Filed: Aug. 6, 2007

Related U.S. Application Data
(63) Continuation-in-part of application No. 11/779,802, filed on Jul. 18, 2007.

(51) Int. Cl. H05B 33/00

(52) U.S. Cl. 313/511

(57) ABSTRACT

A flexible movie theater display is presented. In an exemplary embodiment, the movie display of the invention is in the form of a FLEXED, a flexible emissive display, comprising a flexible substrate, display elements coupled to the flexible substrate, and conductors used to deliver a drive voltage to the display elements. A FLEXED of the invention can be partitioned among conductors to provide a cinema-sized uniformly bright display. A FLEXED of the invention can be mounted on multiple surfaces of a theater to provide a FLEXED Surround experience for the viewer. A FLEXED can be used to display digital recordings, allowing movie studios and distributors to save costs by eschewing film for digital production alternatives. A FLEXED of the invention is an economical lightweight display that is easy to manufacture, distribute and install.

### CROSS REFERENCE TO RELATED APPLICATIONS

This application is a continuation-in-part of U.S. patent application Ser. No. 11/779,802, filed Jul. 18, 2007, entitled “Voltage Partitioned Display,” which is incorporated in its entirety by reference.

### FIELD OF INVENTION

This invention relates generally to movie theater displays, and more particularly, to a large flexible display adapted for a movie theater.

### BACKGROUND OF INVENTION

Motion pictures, having entertained audiences for the better part of a century, and the apparatus and methods used to display them in theaters are widely known in the art. Although video players have become ubiquitous to American households, allowing a viewer to watch a movie in the privacy of his own home, there remains a desire on the part of the public to see movies in a theater to experience the enhanced large screen audio-visual experience that only a cinema can offer.

Typically a movie is presented to an audience by using a projector to cast an image onto a distant screen which in turn reflects the light image back to the audience. The predominant type of projection system employed in commercial and private venues today is the analog or film projection system. FIG. 1 shows a current movie theater projection system 100 typically employed in movie theaters. As shown in the figure, a film projector 110 advances a film reel 105 to cast an image 115 on a movie screen 120. In a typical film projection system, the reel of film 105 is advanced through the analog projector 110 so that each frame of the film 105 is temporarily paused in front of a light source which casts the image on the film 105 through a lens to project the image 115 on to the distant screen 120. The analog movie projector 110 must perform several tasks in order to provide an uninterrupted pleasurable viewing experience for an audience, including film advancement, image projection, and audio decoding. In turn, the movie screen 120 onto which the movie is projected must provide an adequate surface for the proper reflection of the projected image 115 so that audience members seated at varying angles relative to the movie screen 120 can satisfactorily view the projected movie. In addition, the analog projection system 100 composed of the film projector 110 and the movie screen 120 must provide sufficient contrast between light and dark elements of the reflected image 115 that a movie viewer can adequately discern variations in color and brightness so to fully experience the enhanced visual entertainment that today's large screen movie is designed to offer.

In analog systems, as the film is advanced through the projector 110, each frame is paused in front of a light source, which is typically a xenon bulb mounted in the center of a parabolic mirror. Because intense heat is generated by the focused light, the film must be advanced at a sufficiently high speed to prevent melting and distortion of the film. At the same time, projector sprockets must maintain the film in a properly aligned orientation. Typically, film is moved through the projector at a rate of about 24 frames per second, requiring 1.5 feet of film for each second of a movie, resulting in about 2 miles of film for a 2-hour movie. Such an abundance of film must be stored on multiple large reels, requiring about six such reels for the average 2-hour movie.

The large amount of film associated with the average motion picture makes the distribution of movies to theaters across the world an increasingly costly business expense. In addition to the cost of having to duplicate miles of film, distributors must ship bulky, heavy packages to hundreds of movie theaters across the country. As a result, movie studios carefully consider the number, location, and sequence of theaters to which they ship the films. Initially sending out film prints to too many theaters can result in reduced profits should the movie draw less than expected crowds at the box office. Recognizing the potential for financial losses, most movie releases are staggered among various markets. In turn, once a theater has received its film reels for current box office presentations, the operator must offer repeated showings of the films in order to turn a desirable profit before having to return the films. As a result, a single movie print is projected multiple times. Each movie projection gradually degrades the quality of the film by subjecting it to the heat generated by the light source as well as the tensions and forces imposed by the projector as it advances the film, until ultimately the film is no longer usable and a new print must be shown.

To avoid the high costs associated with the production, distribution, and presentation of analog movie films, digital movie cameras and projection systems have been introduced. Digital systems offer the advantage of eliminating the miles of fragile film that must be duplicated, stored, packaged and shipped around the world. The use of a digital camera in lieu of a film camera to record a movie can facilitate the movie-making process by offering a production method that is completely digitized. Contemporary movie producers already employ digital editing techniques to produce a film print of a desired content and quality. Scenes are shot on 35 mm film then scanned to a digital format to facilitate the editing process. However, the analog to digital conversion process can be time-consuming, and, because it is usually performed off-site, a director may not know whether scenes need to be reshot until hours later. In addition, because most theaters employ analog film projectors, the final video product must be in the form of film reels, requiring a reverse digital-to-analog conversion when the editing process is completed. Providing a completely digital process would eliminate the inefficiencies and film degradations produced by traveling back and forth between the analog and digital domains.

In addition, the cost of film is much higher than that of digital media, on the order of a hundred times more expensive. Although a movie shown in a theater may run between 2 and 3 hours, hundreds of hours of film may be shot to produce the 2-hour final version of the movie. Furthermore, once used, film must be discarded if the director is not satisfied by what was captured. Digital recording media, on the other hand are not only less expensive, but can also be reused if initial recordings are not satisfactory, providing a significant savings in media costs.

Digital systems also offer a significant reduction in the number of problems encountered in the movie distribution process. It is simpler and much less expensive to duplicate and distribute digital media than to duplicate and distribute film prints. Furthermore, duplication of a digital recording can produce a duplicate of the same quality as the original, so there is no degradation during the duplication process. Likewise, once received at a theater, a digital recording can be repeatedly shown over an extended period of time without being deformed or degraded like its film counterpart. In addition, digitally-formatted movies can be broadcast by satellite to a receiver at a movie theater which can receive, decode and display the video signal. Utilizing satellite communication capabilities can facilitate the showing of movies at multiple locations at reduced costs by eliminating the need to package and ship movies to individual theaters.

A significant obstacle to an industry-wide transition from analog to digital formats has been the vulnerability of digital recordings to unauthorized duplication and distribution. Piracy of artistic works has long been a legitimate concern of the entertainment industry. The surreptitious recording of a movie while it is shown in the theater and the subsequent duplication of that recording can facilitate black market circulation of illegal copies of current box office movies. In analog projection systems, the advancement of the film frame by frame generates a blanking period in which the screen is dark at regular intervals. The blanking period is not visible to the human eye, but can be captured by recording devices which have response times on the order of microseconds, resulting in a visible black stripe that moves across the picture and substantially diminishes the commercial value of the recording. This phenomenon discourages the surreptitious recording of analog projected films, although such low-quality recordings do abound in markets in which quality is not an issue.

On the other hand, most pioneering digital projection systems emit a continuous stream of light, eliminating the blanking periods inherent to the analog projection process, making it easier to record a movie presentation with a camcorder device. To discourage camcorder recording of a movie projected via a digital projector, some systems incorporate the reflection of light from a movie screen that is imperceptible to the human eye, but can be captured by a camcorder. The camcorder recording is then marred by the presence of extraneous and distracting points of light. However, even without such measures, the resolution of a digital movie that has been filmed with a professional quality camcorder far surpasses that of a surreptitious recording of the movie by a general purpose camcorder. A professional caliber camera generally includes three separate charge couple devices (CCDs) to separately capture red, green and blue wavelengths which are converted to an electrical signal which is subsequently digitized. A typical consumer quality camcorder contains a single CCD for the entire spectrum. As a result, the video recording produced by illegally recording a movie presentation with a consumer grade camcorder would be noticeably inferior, limiting marketability again to those markets in which quality is not much of an issue.

A more significant threat to the integrity of digital works is posed by the interception and/or unauthorized duplication of a movie. As discussed earlier, the duplication of a digital recording can produce a copy of the same caliber and quality as the original. As a result, several techniques have been proposed to mitigate this threat, including: partitioning the video signal, encrypting the data on the digital media so that it can only be accessed by authorized users, and using secure satellite links to broadcast a movie to theaters across the country. The Digital Cinema Initiatives (DCI), a consortium of movie studios and vendors, in conjunction with the Society of Motion Picture and Television Engineers (SMPTE), developed a digital cinema specification to which several movie studies have agreed to comply. The specification designates audio and video signal encoding formats as well as encryption and key management techniques that can be used to prevent piracy of digitally formatted works. Finally equipped with anti-piracy measures, Hollywood stands poised at the threshold of a new digital age in movie production.

Currently, there are three primary types of digital projector systems that circumvent the problems inherent to the analog film projection systems. A first type of digital projection system is one that employs Digital Light Processing (DLP)™ pioneered by Texas Instruments. DLP™ systems employ a Digital Micromirror Device (DMD), an example of which is one manufactured by Texas Instruments and disclosed in U.S. Pat. No. 6,587,159 to Dewald. The DMD is a semiconductor chip that uses hundreds of thousands of tiny tiltable mirrors to reflect light in order to form an image that is projected onto a screen. A prism positioned in front of a light source, such as a lamp, separates incident light into red, green and blue wavelengths, each of which is directed toward a separate DMD. A digital video signal input to the DMD is used to manipulate the micromirrors that cover the DMD so that the prism-directed light is reflected to achieve a desired intensity. The red, green, and blue wavelengths reflected by the individual DMDs are then directed back to the prism to be recombined and ultimately projected to a distant screen. Although adequate for its intended purpose, the DLP™ system relies on optical manipulations that require complex multiple electronic chips equipped with thousands of micromirrors. In addition, each step of the optical processing results in a loss of energy, making the DMD process somewhat inefficient. Another issue encountered with the DLP™ system is often referred to as the “rainbow effect” which is seen as a secondary image on the screen around white objects when the viewer redirects their focus. Although the mechanical life of the DLP™ system may be long, the lamp used as the light source only has an average expectancy of 10,000 hours.

A second type of digital projector is an LCD projector such as the JVC Digital Image Light Amplifier (D-ILA)™. This type of digital projector uses a stationary mirror covered with a liquid crystal display to reflect high intensity light from a light source. By using a digital signal to direct some liquid crystals to let reflected light through, and other liquid crystals to block light, the high intensity beam can be modulated to form an image which can be projected on to a distant screen. Like the DLP system, the D-ILA system relies on optical manipulations of light generated by a high intensity light source that is subject to burnout. Dark pictures often lack sharpness with this technology.

A third type of digital projector is the laser projector, such as the one taught by U.S. Pat. No. 6,774,881 ('881). The '881 laser projector combines pulsed diode lasers with a liquid crystal spatial light modulator. However, laser projection systems have been plagued with resolution, color-range, and cooling problems which have made them unsuitable for large-screen movie theater applications.

Apart from the performance parameters that should be satisfied by the projector to optimize performance, each of the projection systems discussed above must include a movie screen on which an image can be projected. Because many audience members are seated at an angle with respect to the direction of the projected image, a movie screen should provide an effective viewing angle that is greater than that provided by a screen simply formed with a highly reflective medium. In addition, the screen should have very good reflection directivity in both the horizontal and vertical directions. However, satisfying the reflection directivity requirements while at the same time providing excellent gain and contrast, has long posed a problem to screen manufacturers.

Furthermore, a projector is mounted in a projector booth at a proper elevation with respect to theater seating and screen orientation. As a result, projection of the movie is typically limited to a single wall of the theater, limiting the movie presentation to a two-dimensional experience even though speakers can be placed throughout the theater to produce a surround sound experience for a movie patron. One way to present a movie on multiple theater surfaces is to use multiple projectors. However, that method requires that problematic synchronization and edge matching issues be addressed. Disregarding the cost of the additional projection equipment required to simultaneously project images on multiple screens placed on multiple surfaces of a theater showroom, the design of current theaters may make it difficult for the typical theater showroom to accommodate the multiple projectors required in a manner that satisfies projection height and focal length requirements. To avoid the problems encountered when using multiple projectors, a single 70 mm projector in a specially designed theater, such as an IMAX theater can be used. However, the production and distribution of such a movie, and the specially designed dome theater required to present it, can prove expensive.

U.S. Pat. No. 6,733,136 to Lantz, et al., teaches the projection of ultra-wide field-of-view images on a spherical or near-spherical screen. The ultra-wide field of view images are acquired using a novel lens system and presented using “fisheye” projection format and a uniquely designed screen. However, to avoid loss of imagery, the Lantz projection system requires that theater screen and dome geometry, satisfy particular conditions in relation to projector location, which may require expensive remodeling of current theaters in order to use the system. Furthermore, the Lantz system requires several lens subassemblies in addition to the projector used to project the film. The use of a series of lens subassemblies can introduce distortions in the projected images unless the lenses of the subassemblies and the projector satisfy specific requirements.

In summary, each of the digital projection systems described above requires a relatively complex projector, a high intensity light source and a movie screen comprising a surface that provides adequate reflectivity and contrast ratio positioned an adequate distance from a projection booth built at a sufficient height. Furthermore, although digital technology decreases production costs with respect to analog production technology, it is relatively expensive to implement in current theaters. The average cost of a conversion of a legacy theater to a digital theater is estimated to be around $150,000 per screen, discouraging theater owners from enthusiastically supporting the transition to the digital arena and prompting them to clamor for a cost-sharing arrangement with movie distributors.

In recent years, non-projection flat panel technologies such as plasma, and Liquid Crystal Display (LCD displays have become increasingly popular consumer choices for wide-screen television applications. However, these technologies have yet to be considered realistic alternatives to the digital cinema projection systems discussed above. Currently, the largest LCD panels are around 55 inches, and the largest plasma panels available on the market are around 103 inches. While considered “large” compared to standard CRT television displays, the LCD and plasma displays are small compared to the average movie theater screen. In a commercial context, a cinema-sized display typically measures 240 inches or more on the diagonal. In addition, prior art LCD and plasma displays require front and rear sealing which is typically performed using glass. The use of a rigid substance such as glass imposes limits on the size of displays that can be manufactured and the methods by which electrical signals can be applied to operate the displays. The heavy weight of glass makes it difficult to produce a grand display using prior art technologies. In addition, packaging, shipping, and mounting such a large, heavy, and fragile display could also prove prohibitively difficult and expensive. Because such displays are unable to bend or flex due to the rigidity of the substrate on which they are built, prior art flat panel displays are typically limited to a planar orientation which restricts the manner by which they can be mounted. Although LED technology can be used to produce large displays, LED displays are often plagued by resolution problems and viewing angle inconsistencies as well as high power requirements that lead to high operating temperatures. In addition to size requirements, a flat panel display used in theater applications should satisfy certain resolution requirements. For example, current specifications call for three levels of playback: 2K (2048×1080) at 24 frames per second, 4K (1096×2160) at 24 frames per second, and 2K at 48 frames per second. In the past, it has also proven difficult to produce an EL display greater than about 37 inches without being of very large depth and unduly bulky. The same glass problems experienced by the LCD and plasma displays can also be encountered in the production of glass-based EL displays. In addition, as most EL displays are addressable displays utilizing row and column drivers to apply charges to individual pixel elements, the larger the display size, the greater the number of rows and columns of pixels required, and the more difficult it becomes for the drive circuits to adequately address each pixel. As the width and length of a display panel increases, the capacitance and resistance experienced by an electrode that traverses the display also increase, making it difficult to supply the proper drive voltage necessary to illuminate each pixel. As a result, one side of an electroluminescent display panel can appear brighter than the other side, adversely affecting the appearance of the display and inhibiting the manufacture of cinema-sized displays.

In the past, attempts have been made to overcome scalability problems by tiling smaller panels together to form a large display. In general, tiling technology has been plagued with problems such as gaps appearing between panels and a lack of uniformity across the tiled display. U.S. Pat. No. 5,585,695 to Kitai entitled “Thin Film electroluminescent Display Module”, addresses the scalability problem by teaching a large tiled EL display panel. The Kitai apparatus includes a transparent substrate upon which is added a series of conducting, insulating and radiating thin films which comprise a layered film EL structure. A plurality of EL display modules can be tiled together in edge-to-edge relationship to form an electroluminescent display panel. Although adequate for its intended purpose, the Kitai device addresses scalability problems by teaching a tiled display and does not teach a cinema-sized flexible display with uniform brightness adapted to movie theater applications.

What is needed is a movie theater display that can reduce the production and distribution costs associated with current Hollywood movies, while maintaining the integrity of the artistic work. There is a further need for a movie theater display system that eliminates the problems and expenses associated with movie projectors and projection screens. There is also a need for a movie display system that can function without power-draining complex optical operations and high intensity light sources. There is a further need for a movie theater display that provides a viewer with a cinema surround experience by providing images on multiple surfaces of the theater without requiring the mounting of multiple projectors, multiple lens assemblies or extensive remodeling of existing theaters. There is a need for a large emissive movie theater display that achieves a generally uniform brightness across its entirety while maintaining a desired degree of flexibility. There is a need for a flexible movie theater display that can conform to the dimensions of a theater rather than dictate the dimensions of the theater. Finally, there is a need for a movie theater display that can be operated in theaters without the imposition of hefty transition costs on theater owners.

### SUMMARY OF THE INVENTION

The systems, methods and apparatus presented herein provide a flexible, versatile, cost-effective movie theater display that avoids the problems and limitations inherent to current analog projection systems, digital projection systems, and non-projection flat panel technologies. The present invention has the added advantages that it is lightweight, easy to manufacture, easy to ship and easy to install. Additionally, the present invention provides a higher resolution than current movie theater display systems due to the native pixel size of the display. A movie theater display of the present invention comprises a flexible display panel adapted to display a movie. In an exemplary embodiment, a movie theater display of the invention comprises a Flexible Emissive Display (FLEXED) adapted to display movies in a movie theater. In an exemplary embodiment, the FLEXED of the invention is a partitioned emissive display comprising a flexible substrate, a plurality of display elements coupled to the flexible substrate, and conductors adapted to provide a voltage to the display elements. A FLEXED of the invention can be a cinema-sized display having a diagonal measurement of 240 inches or larger. A FLEXED of the invention can be manufactured as a single continuous emissive display panel or may be formed by tiling multiple emissive panels together. A FLEXED of the invention can provide uniform brightness levels across its width, making it an excellent movie theater display. An exemplary method of the present invention includes: receiving a video signal, generating a drive signal in response to said video signal, and generating a display in response to said drive signal.

A FLEXED of the invention can revolutionize the entertainment industry by facilitating the transition of the movie production and display processes from the analog domain to the digital domain in a secure cost-effective manner for movie producers and theater owners alike. A FLEXED of the present invention can be used to display digitally formatted video recordings, allowing movie producers to record, edit and package motion pictures as digital recordings, eliminating the expensive supply costs of film, as well as the temporal and operational costs associated with the analog-to-digital and digital-to analog conversions performed over the course of the movie production process. The FLEXED is capable of displaying video in film-like quality from digital recordings due to its resolution, which for a given screen size is significantly higher than the typical projector and screen system. Because the FLEXED is capable of displaying video in such high resolution, the digital video format would be incompatible with home theater systems, and any stolen or pirated recordings would have very little value on the black market. A FLEXED apparatus of the invention can display encrypted digital recordings stored on a hard disk or a digital video disk (DVD), or other media, or display video signal downloaded over a secured satellite link, thereby preserving the integrity of the artistic work. Because a FLEXED apparatus of the present invention is emissive, generating light rather than reflecting projected light, the FLEXED eliminates the need for analog or digital projectors and their requisite high intensity light sources and projection booths, thereby offering theater owners an alternative that conserves space and decreases operational costs. Similarly, the FLEXED can eliminate the screen reflection issues that plagued prior art projection systems. As an emissive display, light is radiated outward from a display element in an omni-directional pattern.

Because a FLEXED apparatus of the invention is bendable, it can be used to create an enhanced multi-dimensional audio-visual FLEXED Surround experience when positioned to cover multiple walls and/or a ceiling of a theater; so that the viewer feels immersed in the scene. The FLEXED Surround experience adds a video dimension to the surround sound experience, and can be easily implemented by a theater operator. In addition, the FLEXED Surround application provides an advantageous anti-piracy feature as it would be difficult, if not impossible for a viewer to surreptitiously capture the FLEXED Surround imagery using a single camcorder device.

A FLEXED apparatus of the invention can be manufactured in a variety of shapes and sizes to provide a video display that can be customized to a theater operator's needs. For example, in a first exemplary embodiment, the FLEXED can match the average wide screen movie theater screen size having a diagonal measurement around 240 inches or larger. In a further embodiment, a FLEXED can be of smaller dimensions, allowing a theater operator to partition a single large room into multiple smaller rooms with smaller displays so that some movies, such as those produced by independent artists, movies nearing the end of their theater run, those shown in VIP screenings or those reserved by private small groups for special occasions or fundraisers can be viewed in a more intimate setting. Thus, films produced by lesser known entities can be shown to smaller audiences in smaller rooms, avoiding the revenue loss that can be incurred when a sparsely attended film is shown in a full-size theater.

Furthermore, because the FLEXED of the invention is flexible, it can conform to a theater's current dimensions, so that an operator could easily mount the FLEXED by bending it around the corners of a room. Thus a single-sized FLEXED could be mounted in variously sized rooms allowing a theater owner to mount the FLEXED in current theater showing rooms without being compelled to modify the showing rooms. Because it is easily scalable to larger or smaller dimensions, a FLEXED of the invention can also be used to display advertisements in unconventional locations such as around a lobby pillar or around the perimeter of the lobby or theater. The use of a flexible substrate facilitates the manufacture, shipping and mounting of the FLEXED. By using a substrate and sealant other than glass, the constraints related to the rigidity, fracturability, and weight of glass are avoided. The FLEXED of the invention can easily be packaged and shipped to theater locations around the world as it can simply be rolled up, packed in a box, and shipped out.

### BRIEF DESCRIPTION OF THE DRAWINGS

FIG. 1 shows a projector display of the prior art.

FIG. 2 shows an exemplary embodiment of a movie theater display of the present invention.

FIG. 3 shows an exemplary embodiment of a FLEXED of the invention.

FIG. 4 shows an exemplary embodiment of a FLEXED of the invention.

FIG. 5 shows a flow diagram of an exemplary method of the invention.

FIG. 6 shows an exemplary embodiment of the invention.

FIG. 7 shows a Voltage Partitioned Display (VPD) in accordance with an exemplary embodiment of the invention.

FIG. 8 shows a VPD in accordance with an exemplary embodiment of the invention.

FIG. 9A shows a front view of a VPD in accordance with an exemplary embodiment of the invention.

FIG. 9B shows a rear view of the VPD of FIG. 9A.

FIG. 10A shows a front view of a VPD in accordance with an exemplary embodiment of the invention.

FIG. 10B shows a rear view of the VPD of FIG. 10A.

FIG. 11A shows a flow diagram of a method in accordance with an exemplary embodiment of the invention.

FIG. 11B shows a flow diagram of a method in accordance with an exemplary embodiment of the invention.

FIG. 12A shows a VPD in accordance with an exemplary embodiment of the invention.

FIG. 12B shows a VPD in accordance with an exemplary embodiment of the invention.

FIG. 12C shows a VPD in accordance with an exemplary embodiment of the invention.

FIG. 13A shows a front surface of an exemplary embodiment of a tiled VPD of the present invention.

FIG. 13B shows a rear surface of the VPD of FIG. 13A.

FIG. 13C shows an exemplary embodiment of a tiled VPD of the present invention.

FIG. 14 shows a flow diagram of a method in accordance with an exemplary embodiment of the invention.

FIG. 15 shows an exemplary embodiment of a tiled VPD of the present invention.

FIG. 16 depicts a flow diagram of an exemplary method of the invention.

FIG. 17A shows a front view of an exemplary embodiment of a VPD of the invention.

FIG. 17B shows a rear view of the VPD of FIG. 17A.

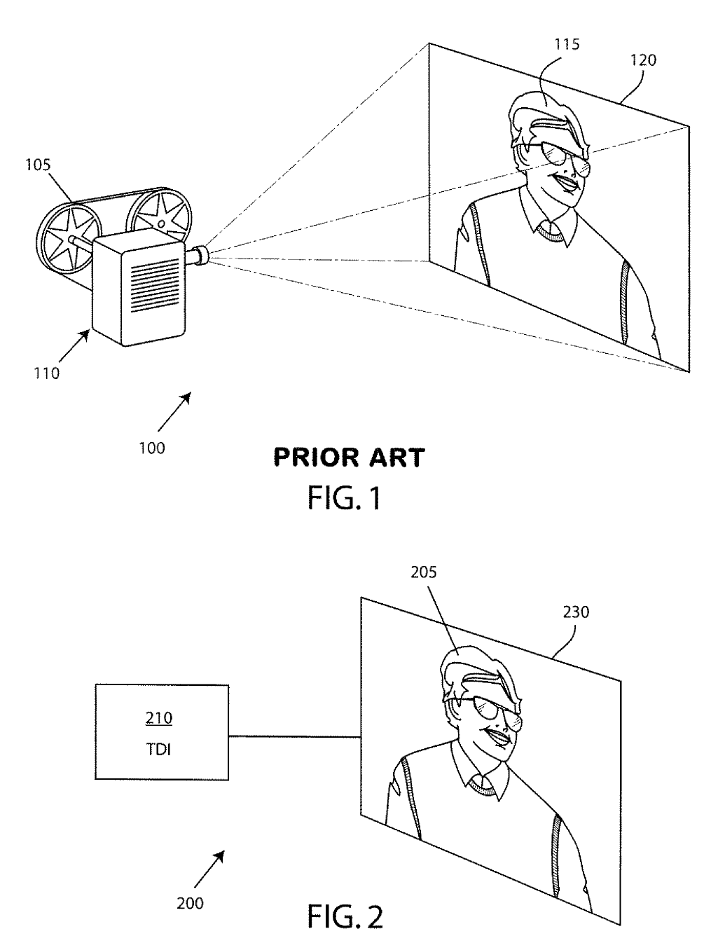

### DETAILED DESCRIPTION

As required, exemplary embodiments of the present invention are disclosed herein. These embodiments are meant to be examples of various ways of implementing the invention and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

### I. Movie Theater Display

The present invention addresses the need for a large movie theater display that avoids the problems associated with current analog and digital projection displays. As discussed above, the display system 100 is plagued by several inherent problems such as the detrimental effects to the film 105 caused by the heat and stresses applied by the projector 110, the difficulties in producing movie screens with the desired reflectivity and contrast, the problems encountered when attempting to project images on multiple surfaces in a theater to simulate an immersed or surround effect for a viewer, and the difficulty in down-sizing a showroom while satisfying projector system requirements such as an adequate distance between the projector 110 and the screen 120 and an adequate projector elevation height. In addition, the production and distribution methods associated with making and delivering the reels of film 105 to theaters around the world are inefficient, outdated, and expensive.

FIG. 2 shows an exemplary embodiment 200 of a movie theater display of the invention that overcomes problems and limitations associated with prior art displays. The movie theater display 200 comprises a Theater Display Interface (TDI) 210 and a flexible display panel 230 adapted to display movies in a movie theater. The TDI 210 is adapted to receive a video signal input representing desired video imagery and generate a drive signal for the display panel 230. The display panel 230 is adapted to receive the drive signal from the TDI 210 and display the desired video imagery. In an exemplary embodiment, the display panel 230 is in the form of a cinema-sized display with a diagonal measurement of at least 240 inches, although it is understood that the display of the invention may be of any size appropriate to the theater. Because the display panel 230 can be manufactured as a cinema-sized display and yet provide a uniformly bright display, it is an excellent candidate for commercial movie theater applications. As shown in FIG. 2, the display panel 230 can provide the wide screen image 205 without a projector or high intensity light source thereby avoiding the costs, complexities, inefficiencies and expenses of prior art movie theater displays.

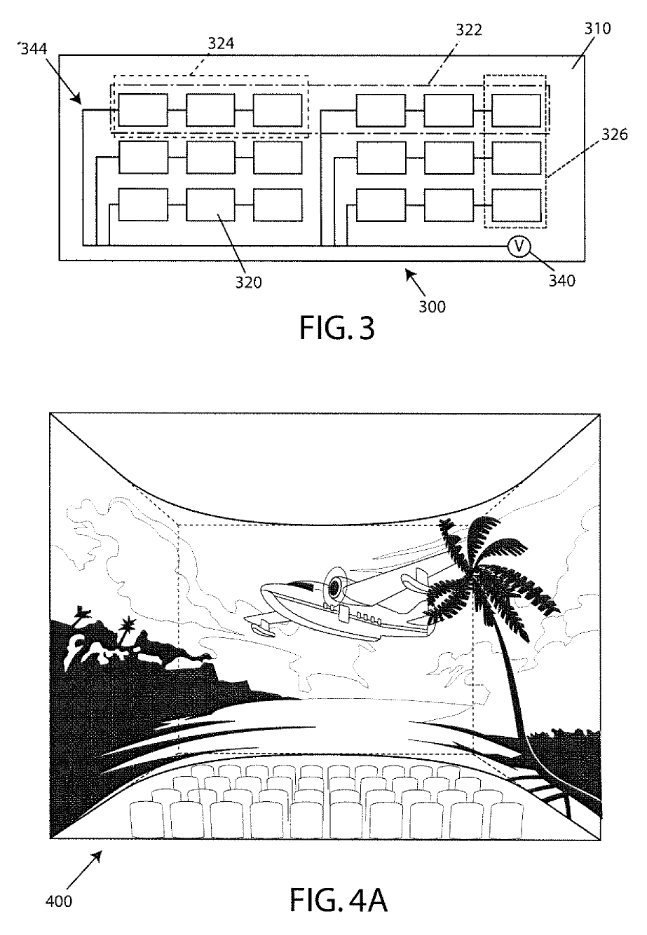

FIG. 3 shows an exemplary embodiment of the display panel 230 of the invention in the form of a Flexible Emissive Display (FLEXED). Referring to FIG. 3, a FLEXED 300 is shown that includes a flexible substrate 310, a plurality of display elements 320 coupled to the flexible substrate 310, and subelectrodes 344 adapted to provide a voltage to the display elements 320 from a voltage source 340. The display elements 320 can form pixels or subpixels of the display panel 230. In an exemplary embodiment, the display elements 320 are arranged in an addressable array of rows 322 and columns 326. By convention, the rows 322 extend along the horizontal width of the FLEXED 300 and the columns extend along the vertical length of the FLEXED 300, however, no limitations regarding display orientation are to be inferred from the use of the row and column nomenclature. The FLEXED 300 is partitioned into a plurality of display subportions 324. In the exemplary embodiment depicted in FIG. 3, the subportion 324 comprises a portion of the row 322. However, it is contemplated that the subportion 324 can be otherwise defined. The subelectrode 344 is adapted to deliver a voltage from a voltage source 340 to a subportion 324. By partitioning the FLEXED 300 into display subportions 324, the subelectrodes 344 need not extend across an entire row 322 of the FLEXED 300. Each display element 320 can receive a scanning voltage and a data voltage, which can illuminate the display element 320 when the combined voltage is greater than the threshold voltage of the display element 320. In prior art emissive displays, a scanning voltage was delivered by a row electrode that extended across the width of a display from a voltage source on a left side of the display, to display elements across the entire width of the display in a far right column. As the distance from the voltage source increased, the resistance and capacitance encountered by the row electrode also increased, thereby reducing the voltage delivered to display elements on the far side of the display, making display pixels on the right dimmer than those on the left. This phenomenon limited the size of the prior art emissive display panels for EL displays to diagonals too small to be considered a legitimate candidate for movie theater applications.

Because the subelectrodes 344 that deliver a voltage do not extend across the entire width of the FLEXED 300, the overall uniformity of the FLEXED 300 display is improved because the disparities between voltages delivered to the display elements 320 on the left side of the FLEXED 300 and those delivered to display elements 320 located on the right side are reduced. Thus, the FLEXED 300 provides a balanced movie theater display. The partitioning of the FLEXED 300 is described below in “Section II. Voltage Partitioned Display” and additionally in U.S. patent application Ser. No. 11/779,802. By partitioning the FLEXED 300 to achieve uniform brightness levels across its width, the FLEXED 300 can be manufactured with dimensions much greater than flat panel displays of the prior art, while achieving the resolution required of a cinema-sized display. In an exemplary embodiment, the FLEXED 300 can achieve a resolution of 3750×5000 or higher using EL elements as the display elements 320.

In an exemplary embodiment, the flexible substrate 310 comprises a thin polymer film such as polypropylene. However, it is contemplated that the flexible substrate 310 could also take the form of a plastic sheet or other polymers. The FLEXED 300 of the present invention avoids the size and weight constraints that limited prior art emissive panels such as EL, LCD and plasma displays because it is manufactured using a lightweight flexible substrate and can be encapsulated in a lightweight covering, such as a polymer film rather than a glass. The use of a thin polymer film facilitates the manufacturing process by allowing roll-to-roll processing techniques to be used.

In an exemplary embodiment, the display elements 320 are electroluminescent (EL) elements, however they may also be display elements of other technologies such as, but not limited to plasma, field-effect and liquid crystal technologies. As EL elements, the display elements 320 can comprise a phosphor sandwiched between insulator layers and electrode layers. When a sufficient voltage is applied across the display element 320 it emits light. The display elements 320 can be variously formed and embodied. In a first exemplary embodiment, the display element 320 can be in the form of a nixel, as discussed in U.S. application Ser. No. 11/526,661 which is incorporated in its entirety by reference. A display element 320 in the form of a nixel can comprise an individually sized and shaped EL apparatus that includes a ceramic substrate, a first charge injection layer on an upper surface of the ceramic substrate, a phosphor layer on top of the first charge. In a further embodiment, the display element 320 can be in the form of a Sphere-Supported-Thin-Film Electroluminescent (SSTFEL) device as described in U.S. Patent Application Publication No. 2007/0069642, which is herein incorporated by reference in its entirety. In a further embodiment, the display elements 320 can be in the form of a wholly-coated spheres. The display elements 320 can be coupled to the flexible substrate 310 by the processes taught in the aforementioned references as well as U.S. Patent Application Publication 2007/0069642.

The subelectrodes 344 can be formed prior to the coupling of display elements 320, or after the coupling, as described below in “Section II. Voltage Partitioned Display” and additionally in U.S. patent application Ser. No. 11/779,802, which teaches a method by which a partitioned electroluminescent display can be manufactured. In an exemplary embodiment, the subelectrodes 344 supply a scanning voltage as described below in “Section II. Voltage Partitioned Display” and additionally in U.S. patent application Ser. No. 11/779,802, which also teaches a manner by which data voltage drivers can be provided.

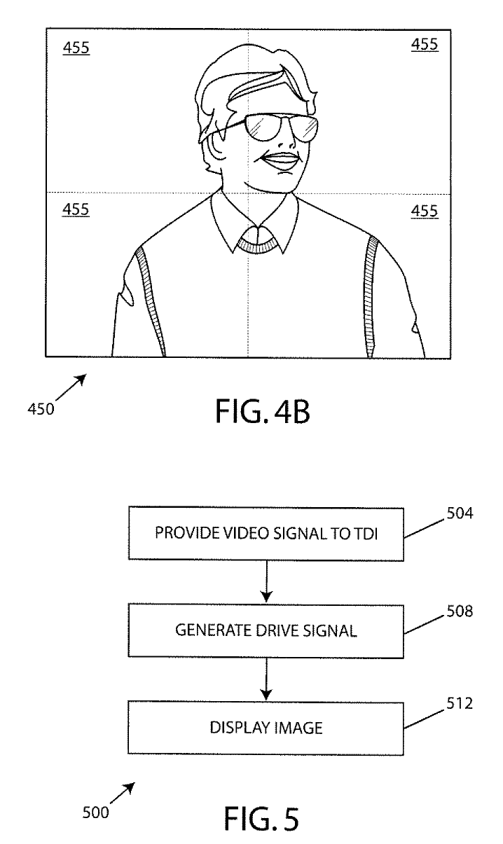

The flexibility of the movie theater display of the invention offers many desirable advantages to movie production companies, theater operators and movie patrons alike. FIG. 4A shows an exemplary embodiment 400 of the FLEXED of the invention. As shown in the Figure, the FLEXED 400 can be flexed or curved to extend around multiple walls of a theater, allowing a viewer to enjoy a cinema-in-the-round experience. With a FLEXED 400 of the invention, movie producers can initiate a new genre of films which exploit this surround cinema feature and offer patrons a multi-dimensioned cinematic experience. Because the flexible substrate 310 is relatively light, theater operators can easily mount the FLEXED 400 on multiple surfaces such as walls and ceilings despite its large size.

Because it can be manufactured using the flexible substrate 310, a display panel 230 of the invention can easily be manufactured in a variety of shapes and sizes to provide a video display that can be customized to a theater operators needs. As mentioned before, the display panel 230 can be a cinema-sized display, sized on the order of a 240″ diagonal, the size of a typical large movie theater screen, or larger. However, the display panel 230 can also be sized smaller than the average theater viewing screen, allowing a theater operator to partition a single large room into multiple smaller rooms providing smaller displays. The smaller rooms with cozier settings allow an operator to show some movies in a more intimate setting, such as those produced by independent artists, those shown in VIP premiers or those reserved by private groups for special occasions or fundraisers. By directing smaller audiences to smaller rooms, the theater owner can avoid the revenue loss that can result when a movie is shown in a room in which a large portion of seats remain vacant. It is noted that although it is easy to produce a display panel 230 customized to fit a particular room, a standard or uniform display size can be used in variably sized rooms because the display panel 230 can be wrapped around the corners of the room. Furthermore, the display panel 230 can be formed from a single continuous substrate tile, or can be formed from a plurality of substrate tiles as described below in “Section II. Voltage Partitioned Display” and additionally in Ser. No. 11/779,802. An example of a tiled display panel 450 is shown in FIG. 4B where the display panel 450 comprises a plurality of display tiles 455. The use of a flexible substrate 310 simplifies the manufacturing process as it eliminates the manufacturing limitations incurred in the use of glass substrates such as, but not limited to, processing temperature restrictions which limit the types of phosphors used to form EL elements in an EL display, and scalability constraints due to the thickness, weight and fragility of glass. Furthermore, the use of a flexible substrate 310 facilitates the coupling of display elements 320 to the substrate 310, as inkjet printing techniques, roll-to-roll processing techniques and other methods that are difficult to implement with glass can be practiced with the flexible substrate 310.

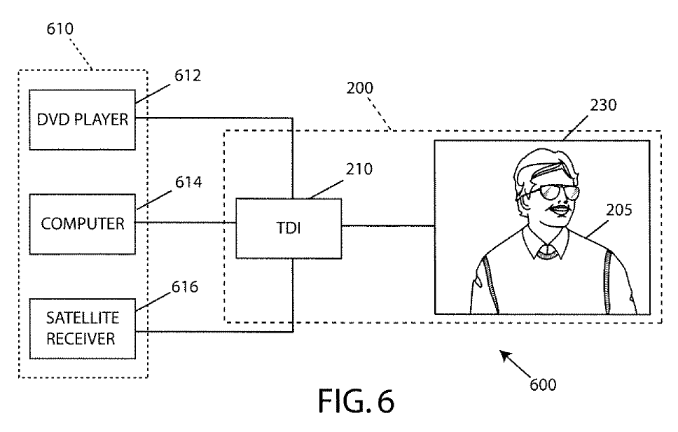

FIG. 5 shows an exemplary method 500 of practicing the invention. At block 504 a video input signal representing desired video imagery data is provided to the TDI 210. In an exemplary embodiment, the video imagery is a movie featured at a movie theater. The movie theater display 200 can be adapted to display movies that are represented or recorded in a variety of formats. Accordingly, in the exemplary embodiment shown 600 in FIG. 6, the TDI 210 can be adapted to receive a video input signal from one or more of a variety of video sources 610 which can decode a signal recorded on a medium or broadcast and provide a video input signal to the TDI 210. In an exemplary embodiment, a movie is recorded in a digital format to facilitate the movie production and distribution processes. For example, a movie may be recorded on a digital video disk (DVD). The digitized imagery data on the DVD can be encrypted to protect against unauthorized use and recording and/or otherwise encoded or partitioned. In an exemplary embodiment, the video data is encoded in a format that complies with that proposed by the DCI. The DVD can be input to a DVD player 612 which can decode the signal stored thereon and supply a video input signal to the TDI 210. It is also contemplated that a magnetic medium, such as that readable by a computer or similar device, may be used to record a video signal. Accordingly, the TDI 210 can receive a video input signal from a computer 614 or other device equipped to decode a magnetically encoded medium. To simplify the distribution of movies to theaters across the globe, it is contemplated that satellite broadcasts can be used to transmit video data to those theaters within the satellite footprint. Accordingly, the TDI 210 can be adapted to receive a video input signal from a satellite receiver apparatus 616. Because the TDI 210 can be adapted to receive a digital video input signal, the movie theater display 200 of the invention can provide a superior display, maintain the advantages of digital movie production, and support digital anti-piracy protections. The TDI 210 of the invention can comprise hardware, software, firmware or a combination thereof.

In a further embodiment of the invention, the various decoding and decryption operations that can be performed by the video sources 610 can be performed by the TDI 210. Accordingly, the TDI 210 may comprise a laser adapted for optical detection of video stored on a DVD, a receiver adapted to receive a satellite signal, as well as means as known in the art for receiving, decoding, decrypting, and otherwise manipulating a received signal.

At block 508, the TDI 210 generates a drive signal for the display panel 230 so that the proper voltage can be applied to the display elements 320 to form a desired illumination pattern. In an exemplary embodiment, the drive signal comprises a data voltage drive signal. The data voltage drive signal can be used to drive a voltage driver chip such as described below in “Section II. Voltage Partitioned Display” and additionally in U.S. patent application Ser. No. 11/779,802. For example, the data voltage drive signal can be a digital signal that includes display element 320 addressing information as well as applied voltage information. For example, the applied voltage information can have a value of 1 to indicate an applied voltage of +50 V, and a 0 to indicate an applied voltage of −50 V, and the addressing information can identify a display element 320 by its row and column location. The drive signal can also contain clock and synchronization signals, as well as other signals used to drive the display panel 230. A scanning voltage signal may also be provided at block 508. The scanning voltage can be controlled by the TDI or by a separate controller coupled to the display panel 230.

The TDI 210 may be a detached stand-alone device that is communicatively coupled to the display panel 230 by a wire, cable, or wirelessly (such as IR, RF, Bluetooth, etc.) or other means in order to deliver the generated drive signal to the display panel 230. In a further embodiment, the TDI 210 can be integrated with the display panel 230 to form a movie display unit.

At block 512, the display panel 230 can display an image in response to the drive signal received from the TDI 210. In an exemplary embodiment in which the display elements 320 are EL elements, an image can be generated in response to a drive signal as described below in “Section II. Voltage Partitioned Display” and additionally in U.S. patent application Ser. No. 11/779,802. In the exemplary embodiment wherein the display panel is in the form of the FLEXED 300, light is radiated in all directions, eliminating angle of reflection and contrast problems encountered in prior art projection systems that reflect light off a projection screen. To further increase the brightness of the display panel 300 embodied as an EL display, plastic lenses can be positioned under the EL display elements 230 to redirect light outward from the display.

The present invention provides a flexible movie theater display that can provide an enhanced audio-visual experience. The movie display of the invention eliminates the problems associated with prior art displays by presenting a bright, cinema-sized, uniform, and economical projector-less display that can be easily manufactured and installed. The movie display of the invention can display digital recordings, allowing production studios to save costs by moving away from film to the use of digital media. It can be used to display digital movies in a way that provides a high quality presentation while protecting the integrity of the work. A movie display of the invention can be mounted on multiple walls to provide a FLEXED Surround experience for the viewer. A movie display of the invention can be used in both large and small screening rooms, providing a theater owner the opportunity to offer patrons various viewing options and permit the showing of movies to small audiences without the risk of a high loss of revenue. The movie display of the invention offers economical advantages to movie producers, distributors, and theater operators alike, while offering viewers an enhanced audio-visual experience.

### II. Voltage Partitioned Display

The following disclosure of embodiments of voltage partitioned displays are provided in support of the disclosure of the earlier-described embodiments of the movie theater display. While this disclosure is intended to support the disclosure of embodiments of the movie theater display, it is not intended to limit the full scope of embodiments of the movie theater display.

The methods and apparatus provided herein are directed to a Voltage Partitioned Display (VPD) which can provide a uniformly bright display throughout, regardless of its size. In a first exemplary embodiment, a VPD of the present invention can be a monolithic display panel formed on a continuous substrate. The VPD is voltage partitioned into a plurality of display subportions, with each display subportion provided a voltage by a subelectrode. The display subportions and subelectrodes are arranged so that display subportions across the VPD receive similar voltages, thereby providing a display panel with uniform brightness throughout. A voltage bus conductor adapted to deliver a voltage from a voltage source to the plurality of subelectrodes is provided. In an exemplary embodiment, the subelectrodes can be formed on a first surface, for example a front surface, of the display substrate, and the voltage bus conductor can be formed on a second surface of the display substrate, for example a rear surface. Electrical connectivity can be established between the two opposing surfaces by z-axis vias that extend from the front surface through the substrate to the rear surface. By providing the voltage bus conductor and connections thereto on the rear surface, the invention offers flexibility in the sizing and positioning of the voltage bus and connections, since components disposed on the rear surface do not encroach on the display area occupied by the display elements on the front surface.

In a further exemplary embodiment, a VPD of the invention comprises a plurality of display tiles joined together to form a tiled display panel. VPD display subportions can be defined to a single tile, or defined as including portions of multiple tiles. The display tiles used to form a tiled VPD can be variously sized; for example a large display tile can be joined to multiple smaller display tiles. Thus, a VPD can be economically custom-sized to suit a user's requirements. The display tiles used to form a tiled VPD can be tested prior to VPD integration in order to improve manufacturing yield. In addition, the display tiles can be joined in a manner that allows removal of a damaged or malfunctioning display tile and replacement with a new display tile. Although referred to herein as an emissive display comprising display elements, the VPD of the present invention can include displays such as, but not limited to, electroluminescent, plasma, and field emission displays, as well as light-valve displays such as liquid crystal displays (LCDs) and other current and future display technologies.

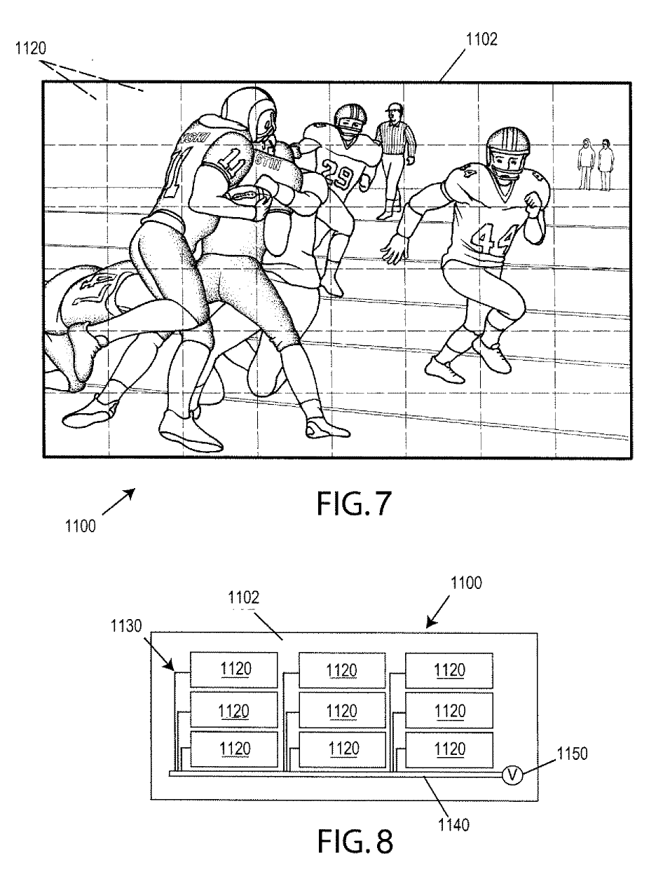

Turning to the figures, wherein like numerals represent like features throughout the views, FIG. 7 shows an exemplary embodiment 1100 of a VPD of the present invention. Referring to FIG. 7, the VPD 1100 comprises a continuous substrate 1102, and a plurality of display subportions 1120, each subportion 1120 receiving a partitioned voltage from a voltage source (not shown). In an exemplary embodiment, the continuous substrate 1102 is a flexible substrate. As shown in FIG. 8, the VPD 1100 includes a plurality of subelectrodes 1130, each adapted to deliver a voltage to at least one display subportion 1120, and a voltage bus 1140 electrically coupled to the subelectrodes 1130 and adapted to provide a voltage thereto from a voltage source 1150. The display subportion 1120 and subelectrode 1130 can be defined so that the line resistance and capacitance encountered by the subelectrode 1130 does not significantly affect the voltage delivered to the subportion 1120. As a result, each subportion 1120 of the VPD 1100 can receive approximately the same voltage so that the VPD 1100 can provide a uniformly bright display. Thus the VPD 1100 forms a voltage partitioned display of uniform brightness. It is noted that although the subportions 1120 are shown as equivalent in size, it is contemplated that subportions 1120 and subelectrodes 1130 may vary in size, in which case the variably sized subportions 1120 across the VPD 1100 can still be provided with substantially the same voltage.

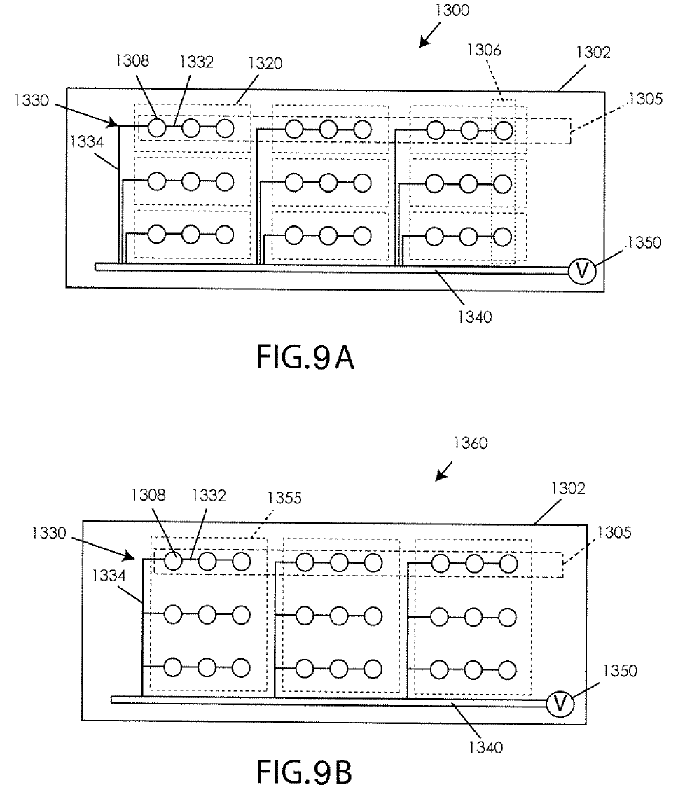

FIG. 9A provides an illustration of a VPD 1300 of the invention. Referring to FIG. 9A, the VPD 1300 comprises a plurality of display elements 1308 arranged in an addressable matrix of orthogonal rows 1305 and columns 1306. However it is contemplated that other arrangements of display elements 1308 can also be employed. Further, as discussed herein for teaching purposes, the rows 1305 are defined to run horizontally across the length of the VPD 1300, and the columns 1306 defined to run along the height of the VPD 1300. However it is contemplated that rows and columns could be otherwise defined.

As mentioned previously, a VPD of the invention is partitioned into a plurality of display subportions 1120 adapted to receive substantially the same voltage, thereby reducing or eliminating luminosity differences across the display. As shown in FIG. 9A a subportion 1320 is defined as a portion of a row 1305 of display elements 1308, however the subportion 1320 may be alternatively defined. For example, a VPD 1360 may contain a subportion 1355 defined as containing portions of a plurality of rows 1305 as shown in FIG. 9B. As shown in the exemplary embodiment 1300 depicted in FIG. 9A, the subelectrode 1330 can comprise two parts: a subconductor 1332 that interconnects the display elements 1308 contained within the subportion 1320, and a subconductor connector 1334 which connects the subconductor 1332 with the voltage bus conductor 1340. The subelectrode 1330 can comprise a subconductor 1332 and subconductor connector 1334 that are joined at their intersection; or may comprise a continuous element that extends from the voltage bus conductor 1340 to the display elements 1308 contained within the subportion 1320.

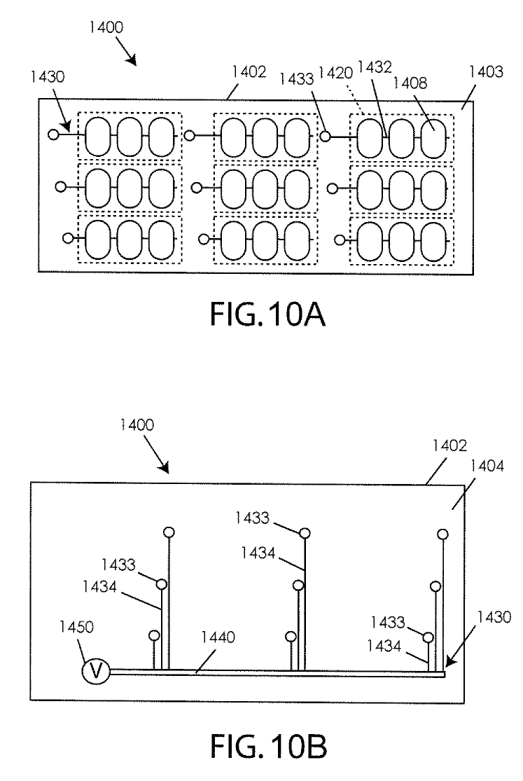

FIGS. 10A and 10B show an exemplary embodiment 1400 of a VPD of the invention in which a plurality of display elements 1408 are formed on a front surface 1403 of a substrate 1402, and a voltage bus conductor 1440 is formed on a rear surface 1404 of the substrate 1402. As shown in FIG. 10A, the VPD 1400 is partitioned into a plurality of display subportions 1420, each containing a plurality of display elements 1408 and coupled to a subelectrode 1430 which comprises a subconductor 1432 and subconductor connector 1434. Vias 1433 are provided to allow electrical connectivity between the front surface 1403 of the substrate 1402 and the rear surface 1404 of the substrate 1402. The subconductor 1432 on the front surface 1403 of the substrate 1402 is electrically connected to a subconductor connector 1434 on the rear surface 1404 through the via 1433 to complete the subelectrode 1430. FIG. 10B shows the rear surface 1404 of the substrate 1402 of the VPD 1400. As shown in FIG. 10B, the subconductor connector 1434 can extend from each via 1433 to the voltage bus conductor 1440 which provides connectivity with a voltage source 1450. A subconductor connector 1434 can be electrically connected to more than one subconductor 1432.

Referring to FIG. 10A, in an exemplary embodiment, the substrate 1402 is a flexible substrate. For example, the substrate 1402 can comprise a thin polymer film such as polypropylene, polyester, or Kapton®. Alternatively the substrate 1402 can comprise other polymers or a plastic sheet. By using a flexible material for the substrate 1402, a flexible VPD can be formed that is rugged yet lightweight; allowing a VPD of the invention to avoid the size limitations imposed by heavy substrate materials such as glass that were used in the prior art. In addition, the use of a flexible material such as a thin polymer film allows high yield manufacturing techniques such as roll-to-roll processing to be employed in the manufacture of the VPD 1400. Furthermore, the use of a lightweight flexible material for the substrate 1402 facilitates the distribution and installation of the VPD 1400 as it can easily be rolled up, transported in a tube or carton, then unrolled and mounted on a wall.

The substrate 1402 is partitioned into a plurality of display subportions 1420 adapted to receive a voltage from a subelectrode 1430, which comprises the subconductor connector 1434 and one or more subconductors 1432 to which it is electrically coupled. To optimize display performance, it is desirable that the display subportions 1420 and the subelectrodes 1430 be defined so that the voltage delivered to a first display subportion 1420 by a first subelectrode 1430 is substantially the same as that delivered to a second subportion 1420 by a second subelectrode 1430. The via 1433 can provide electrical connectivity between the front 1403 and rear 1404 surfaces of the substrate 1402. In an exemplary embodiment, the subelectrode 1430 provides a scanning voltage to the display subportion 1420. Discrepancies in scanning voltage led to many of the previously discussed uniformity problems associated with prior art displays. By voltage partitioning the VPD 1400 into display subportions 1420 that receive substantially the same scanning voltage, uniformity problems of the prior art can be avoided. In a preferred embodiment, the subelectrode 1430 comprises a subconductor 1432 disposed on the front surface 1403 and a subconductor connector 1434 disposed on the rear surface 1404. The subelectrode 1430 can be fabricated using a metallic substance, such as aluminum, rather than a transparent conductive film such as ITO, which has a much higher resistance. The use of a lower resistance material further improves the VPD 1400 performance by reducing resistance losses over its width.

The display elements 1408 can form pixels or subpixels for the VPD 1400. In the VPD 1400, the display elements 1408 are arranged in orthogonal rows and columns to form an addressable array on the front surface 1403 of the substrate 1402. As mentioned previously, in the context herein the display elements 1408 can encompass a variety of pixel or subpixel producing elements that can be used to produce a variety of display types including, but not limited to electroluminescent displays, plasma displays, field emission displays, and liquid crystal displays. In an exemplary embodiment, the display elements 1408 comprise electroluminescent elements that radiate light when a sufficiently high voltage is applied. In a first exemplary embodiment the display elements 1408 are in the form of a nixel. A display element 1408 in the form of a nixel can comprise an individually sized and shaped EL apparatus that includes a ceramic substrate, a first charge injection layer on an upper surface of the ceramic substrate, a phosphor layer on top of the first charge injection layer a second charge injection layer on top of the phosphor layer, an upper electrode on the upper surface of the second charge injection layer, and a lower electrode on the lower surface of the ceramic substrate. In a further exemplary embodiment, the display elements are in the form of an SSTFEL as taught by U.S. Patent Application Publication No. 2007/0069642 entitled Sphere Supported Thin Film Phosphor Electroluminescent Device, which is hereby incorporated in its entirety by reference. In an additional embodiment, the display elements may be in the form of a nixel, SSTFEL, or other emissive element utilizing single-sided contacts as taught by U.S. patent application Ser. No. 11/683,489 entitled Electroluminescent Nixels and Elements with Single-Sided Electrical Contracts, which is herein incorporated in its entirety by reference.

Referring to FIG. 10B, the voltage bus conductor 1440 can be disposed on the rear surface 1404 of the substrate 1402. In a preferred embodiment, the voltage bus conductor 1440 comprises a metallic substance such as aluminum. The voltage bus conductor 1440 is electrically connected to the voltage source 1450 which can provide a drive voltage for the VPD 1400. In an exemplary embodiment, the voltage source 1450 provides an ac scanning voltage of around 250V to the VPD 1400. The voltage source 1450 can be placed along the perimeter of the substrate 1402 to maximize the flexibility of the VPD 1400. Alternatively, the voltage source 1450 can be placed anywhere on the rear surface 1404 of the substrate 1402 and adapted to provide a voltage to the voltage bus conductor 1440.

In a preferred embodiment, the subconductor connectors 1434, preferably comprising a metallic substance such as aluminum, are provided on the rear surface 1404 of the substrate 1402, and are electrically coupled to the voltage bus conductor 1440. As shown in FIG. 10B, the voltage bus conductor 1440 is coupled to a plurality of subconductor connectors 1434, each of which extends to at least one via 1433. The via 1433 provides electrical connectivity between the subconductor connector 1434 and the subconductor 1432 which together form the subelectrode 1430 that provides a voltage to the subportion 1420. The via 1433 can comprise, by way of example and not limitation, a conductive material such as a solder, a conductive paste, a conductive ink, a metallic substance, or other like material which can provide electrical connectivity. Thus, the subelectrode 1430, comprising the subconductor 1432 and the subconductor connector 1434, can deliver a voltage to the subportion 1420 from the voltage source 1450 via the voltage bus conductor 1440. The subportion 1420, the subconductor 1432, the subconductor connector 1434 and the voltage bus conductor 1440 are apportioned so that each subportion 1420 receives substantially the same voltage from the voltage source 1450, in order to form a uniformly bright display. One or more voltage sources 1450 can be used to drive the VPD 1400. In an exemplary embodiment the voltage source 1450 provides a scanning voltage.

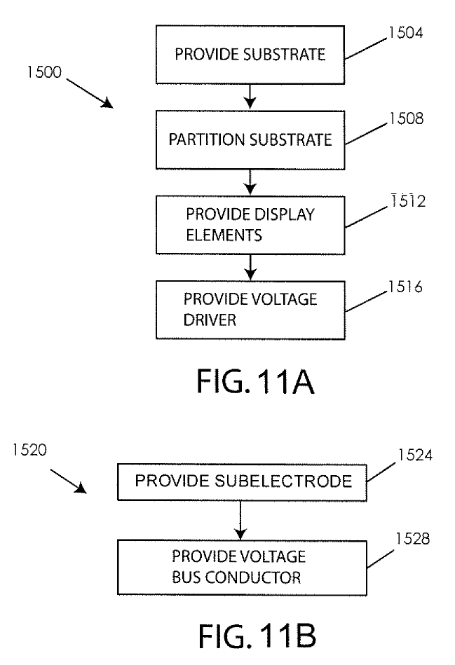

FIG. 11A shows an exemplary method 1500 of the invention. The display substrate 1402 can be provided at block 1504. As discussed earlier, in an exemplary embodiment a flexible material such as a thin polymer film can be provided as a substrate so that a flexible VPD can be produced. At block 1508, the display substrate 1402 can be voltage partitioned.

FIG. 11B shows an exemplary method 1520 for partitioning a display substrate. At block 1524, a plurality of subelectrodes 1430 can be provided to the display substrate 1402. The subelectrode 1430 is adapted to provide a voltage to a subportion 1420. The subelectrode 1430 can comprise the subconductor 1432 on a front surface 1403 of the display substrate 1402 and the subconductor connector 1434 on a rear surface 1404 of the display substrate 1402. The subconductor 1432 and the subconductor connector 1434 can be electrically coupled by the z-axis via 1433. In an exemplary embodiment, the vias 1433 can be formed by first using a drill or punch tool to penetrate the substrate 1402 to form a hole, and then filling the hole with a conductive substance. On the front surface 1403 of the substrate 1402, subconductors 1432 can be formed. The subconductors 1432 can comprise thin film conductors, preferably metallic, that can be formed by a variety of processes known in the art, such as plating, evaporation, sputtering printing, or laminating. The subconductor 1432 can be formed so that it is electrically coupled to the via 1433 and adapted to provide a voltage to a subportion 1420 of the display substrate 1402. On the rear surface 1404 of the display substrate 1402, a plurality of subconductor connectors 1434 can be formed by the techniques suggested above for the formation of the subconductors 1432. In a preferred embodiment, the subconductor connectors comprise a metallic substance such as aluminum. The subconductor connectors 1434 are electrically coupled to the vias 1433 so that electrical connectivity can be established between the subconductors 1432 and the subconductor connectors 1434. A subconductor connector 1434 can be electrically coupled to more than 1 via 1433 in accordance with a desired subportion and subeletrode design.

At block 1528 a voltage bus conductor 1440 can be provided. The voltage bus conductor 1440 is appropriately sized and positioned so that it can connect to a plurality of subconductor connectors 1434. In an exemplary embodiment, the voltage bus conductor 1440 comprises a metallic substance and can be formed by using one of the many techniques known in the art, such as, but not limited to, plating, sputtering, printing, laminating, or evaporation.

Referring back to FIG. 11A, after partitioning of the substrate, at block 1512 the display elements 1408 can be provided to the front surface 1403 of the substrate 1402. The display elements 1408 can be embodied in a variety of forms as discussed previously herein. In an exemplary embodiment, the display element 1408 is in the form of a nixel, and can be coupled to the subconductor 1432 in a predetermined location so that the display element 1408 can properly function as a pixel or subpixel of the VPD 1400. For example, the nixel can be coupled to the subconductor 1432, by soldering or other methods (e.g., solder paste, conductive epoxy, other conductive adhesive, etc.) taught by the earlier referenced U.S. patent application Ser. No. 11/526,661, so that the bottom electrode of each nixel is electrically coupled to the subconductor 1432. At block 1516, voltage drivers and driver circuitry can be provided. The voltage source 1450 can be coupled to the voltage bus conductor 1440 and adapted to deliver a scanning voltage to the display subportions 1420.

In an exemplary embodiment of the invention, the display elements 1408 are electroluminescent elements arranged in a passive matrix array that receive both a scanning voltage and a data voltage. When the combined voltage applied to a display element 1408 exceeds a threshold voltage, the display element 1408 radiates light; otherwise the display element 1408 remains dark. A common scanning voltage is applied to all the display elements 1408, but the data voltage applied to each display element 1408 varies in accordance with the image to be displayed.

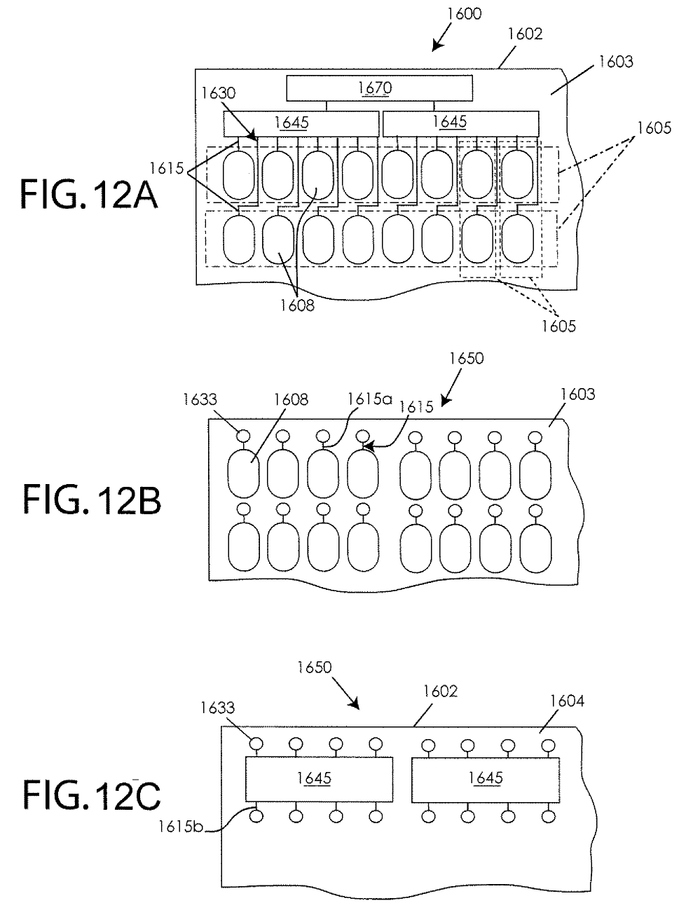

In a first exemplary embodiment, a data voltage is supplied by a data voltage driver that is electrically coupled to a plurality of display elements. FIG. 12A shows an exemplary embodiment 1600 of a VPD of the invention. The VPD 1600 includes a plurality of display elements 1608 coupled to a front surface 1603 of a substrate 1602. A data voltage driver 1645 is used to supply a data voltage to the display elements 1608 in columns 1605.

In an exemplary embodiment, the display element 1608 is in the form of a nixel that includes a top electrode layer, preferably formed from a transparent conducting material such as ITO. A transparent insulating layer can be deposited on the front surface 1603 of the substrate 1602 in such a manner that the top electrode layers of the display elements 1608 are left exposed. Leads 1615 can be formed over the insulating layer to extend from the top electrode of each display element 1608 to a pad (not shown) which provides electrical connectivity between the lead 1615 and a pin of the data voltage driver 1645. In an exemplary embodiment, the leads 1615 are formed from a transparent conductive material such as ITO. The leads 1615 are disposed so as not to interfere with the interpixel spacing on the VPD 1600, and the deposited insulating layer prevents contact between the leads 1615 and the row subelectrodes 1630.

In an alternative exemplary embodiment, the display elements may be in the form of a nixel with single-sided contacts, in which the row and column electrodes of the display element are both disposed on the same side of the element, preferably the non-emitting side. These electrodes are electrically separated by a small gap or other insulating material. The element may be directly physically and electrically connected to the substrate, with row or column electrodes connected to the vias to the rear surface of the substrate.

The data voltage driver 1645 is adapted to apply a data voltage to the display elements 1608 in synchronization with other data voltage drivers 1645 and voltage sources 1650 (not shown) that may be employed by the VPD 1600. A controller 1670 may be used to provide synchronization and control signals to a plurality of data voltage drivers 1645 and voltage sources. Placement of the voltage drivers 1645, the scanning voltage sources, and the controller 1670 around the periphery of substrate 1602 can improve the overall flexibility of the VPD 1600. As shown in FIG. 12A, in an exemplary embodiment, the data voltage driver 1645 is electrically coupled to a plurality of display elements 1608 disposed in separate rows 1605. In this manner a plurality of rows 1605 can be illuminated simultaneously when both a data voltage and a scanning voltage are provided.

FIGS. 12B and 12C show a further exemplary embodiment 1650 in which z-axis vias 1633 are provided proximate to each display element 1608. The lead 1615 can extend from a top electrode, or alternatively from an electrode on the non-emissive side of the display element in the case of single-sided contacts, of the display element 1608 through the z-axis via 1633 to pads disposed on a rear surface 1604 of a substrate 1602. In this embodiment, a portion 1615b of the lead 1615 extending from the voltage chip pad is disposed on the rear surface 1604 of the substrate 1602 (FIG. 12C). Because it is disposed on the rear surface 1604, the portion 1615b need not be transparent, and can comprise a metallic substance such as aluminum that has a lower resistance than ITO. In this configuration, the data voltage driver 1645 can be placed along the perimeter of the substrate 1602, or any where on the rear surface 1604 of the substrate 1602. A portion 1615a of the lead 1615 is disposed at the front surface 1603 of the substrate extending from the top electrode of the display element 1608 to the via 1633. Lead portion 1615a may be transparent or opaque and can comprise a substantially transparent conductor or a thin metallic wire that does not interfere with light emission from the display at normal viewing distance. Other conductors may be used.

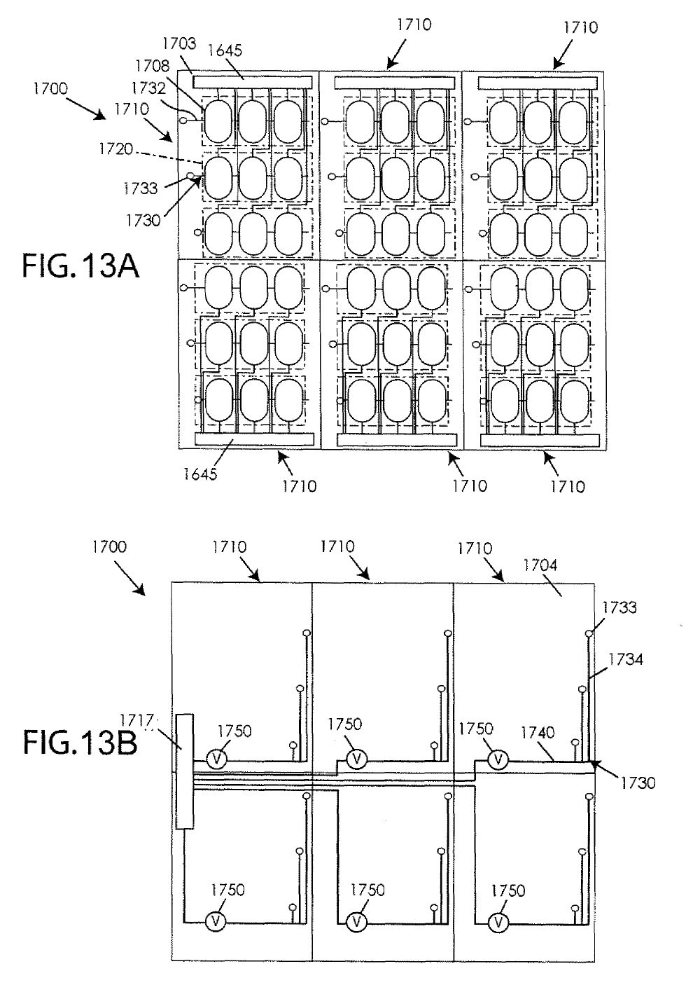

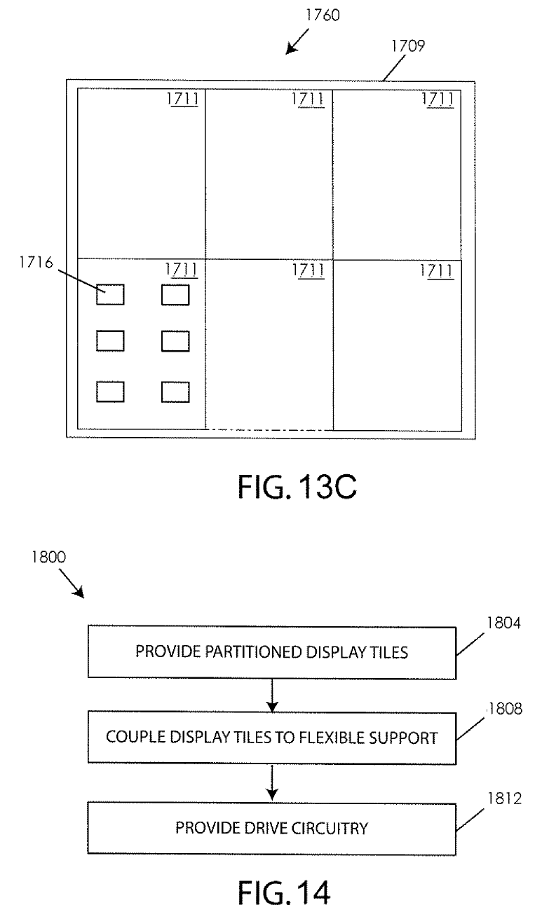

In a further exemplary embodiment 1700, the VPD is in the form of a tiled display. Referring to FIG. 13A, the VPD 1700 comprises a plurality of display tiles 1710. The display tiles 1710 are joined together so that seams between the display tiles 1710 fall within the display element 1708 pitch so as not to be apparent to a viewer. The VPD 1700 is voltage partitioned to include a plurality of display subportions 1720, a plurality of subelectrodes 1730, which comprise a subconductor 1732 and a subconductor connector 1734, at least one voltage bus conductor 1740 and at least one voltage source 1750. As shown in FIG. 13B, the subconductor connectors 1734 and voltage bus conductor 1740 can be disposed on a rear surface 1704 of the VPD 1700 and electrically coupled to the front surface 1703 by vias 1733. A controller 1717 can be used to provide synchronization signals to the voltage sources 1750 to coordinate synchronous operation of the display 1700.

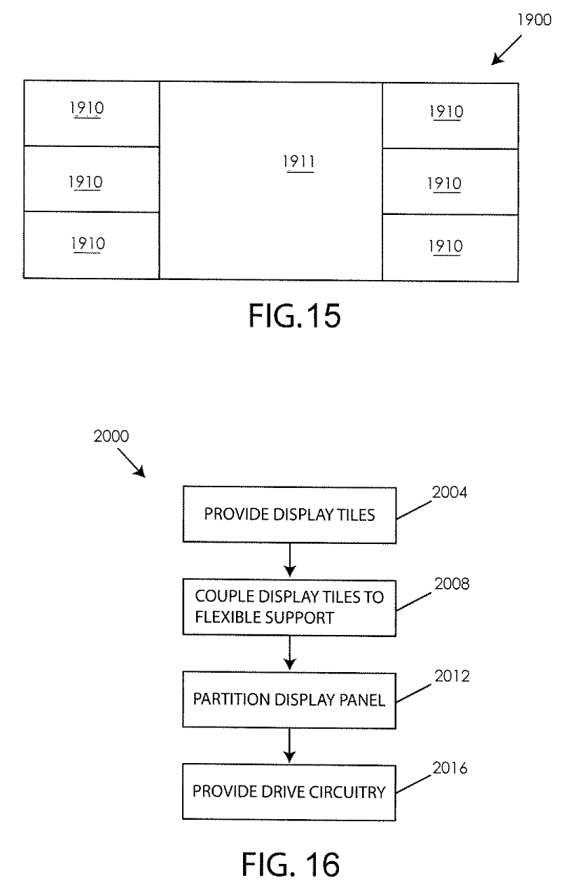

An exemplary method 1800 of the invention for providing a tiled display 1700 is depicted by the flow diagram of FIG. 14. At block 1804 a plurality of partitioned display tiles 1710 can be provided. In a first embodiment, the display tiles 1710 are partitioned prior to integration into the VPD 1700. This allows the operation and performance of each display tile 1710 to be tested prior to joining the display tiles 1710 to form a tiled panel, so that manufacturing yield can be increased. A partitioned display tile 1710 can comprise subportions 1720, subelectrodes 1730 and at least one voltage bus 1740. A partitioned display tile 1710 may also include a data voltage driver 1645 and/or a voltage source 1750. The display tiles 1710 shown in FIG. 13 are uniformly sized. However, as shown in FIG. 15, display tiles 1910 and 1911, which vary in size can be provided at block 1804 and joined to form a tiled VPD 1900. At block 1808, the plurality of display tiles 1710 can be coupled to a flexible support to form a tiled display. In an exemplary embodiment 1760 as shown in FIG. 13C, a support 1709 is provided which has a plurality of spaced-apart recesses 1711 that are adapted to receive the display tiles 1710. In an exemplary embodiment, the support 1709 is a flexible support comprising a polymer sheet. To assist in the retention of the display tiles 1710 to the flexible support 1709 an adhesive 1716 may be provided to the display tiles 1710 or to the support 1709. For example, silicone may be used. The recesses 1711 are spaced so that adjacent display tiles 1710 can be positioned in a manner that maintains the spacing between display elements 1708 across the display 1700. The use of a flexible support 1709 allows the tiled VPD 1700 to be a large panel flexible display. At block 1812 data voltage drivers and circuitry can be provided if not previously provided on the partitioned display tile 1710. A controller 1717, and connections thereto can be provided to the VPD 1700 as shown in FIG. 13B. The controller 1717 can be adapted to coordinate the scanning and data voltages applied by the one or more data voltage drivers that provide a data voltage and voltage sources 1750 that provide a scanning voltage, so that the proper display elements 1708 can be illuminated to form a desired image. In a preferred embodiment, the flexible support 1709 can receive the display tiles 1710 face down so that a controller 1717, and connections thereto, can be provided on a rear surface of a display tile 1710.

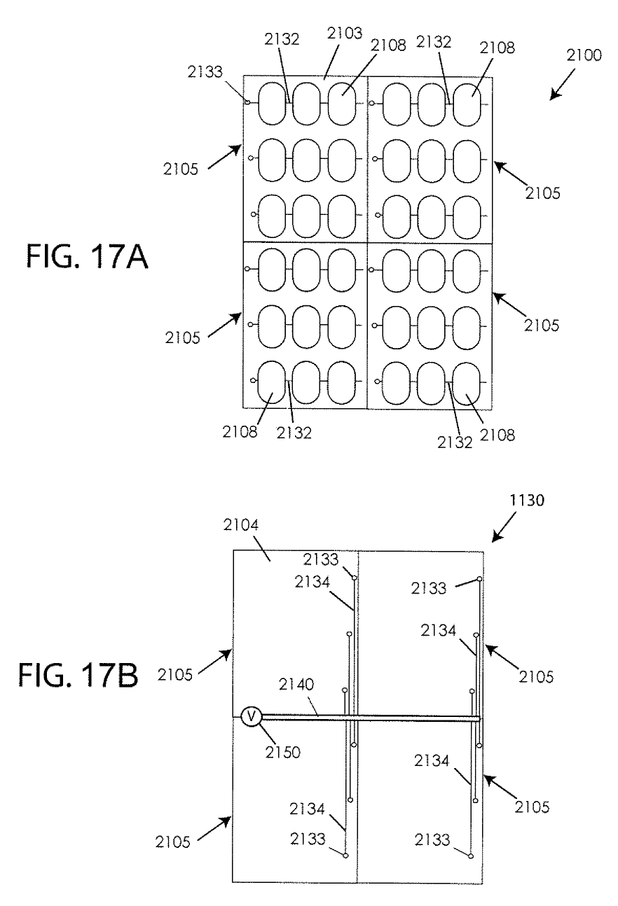

FIG. 16 shows a further exemplary method 2000 of the invention. Referring to FIGS. 16, 17A, and 17B, at block 2004 a plurality of display tiles 2105 are provided. The display tiles 2105 need not be uniformly sized. In this embodiment, the display tiles 2105 can include a plurality of display elements 2108 on a front surface 2103 of the display tile substrate. The display elements 2108 can be coupled to a subconductor 2132. The display tiles 2105 may also comprise vias 2133 that provide electrical connectivity between the front 2103 and rear 2102 surfaces of the display tiles 2105. At block 2008 the display tiles can be provided to a flexible support as discussed above to form a tiled display panel. At block 2012, the tiled panel can be partitioned into subportions that can receive substantially the same voltage from a voltage source 2150. One or more voltage bus conductors 2140 can be provided to the rear surface of the tiled panel. A plurality of subconductor connectors 2134 can be provided on the rear surface adapted to connect with the voltage bus conductor 2140. The subconductor connectors 2134 can connect with the subconductors 2132 on the front surface through the vias 2133 to form completed subelectrodes. The subconductors 2132, subconductor connectors 2134, and voltage bus conductor 2140 can be sized and positioned so that subportions 2130 across the VPD 2100 can receive substantially the same voltage from the voltage source 2150. At block 2016, data voltage drivers and scanning voltage sources can be provided on a rear surface 2104 as well as connections thereto. A controller can be provided to provide timing, synchronization and other control signals to the various voltage drivers and sources.

Because the drive circuitry can be placed on a rear surface 2104 of the VPD 2100, there is flexibility in the sizing and arrangement of the voltage bus conductor 2140 and the subconductor connectors 2134. Thus the voltage bus conductor 2140 can be made sufficiently wide and long to connect with a plurality of subconductor connectors 2134 without experiencing significant losses.

Thus the present invention provides methods and apparatus for a voltage partitioned display panel that includes a plurality of display subportions that receive substantially the same voltage, thus providing a uniformly bright display panel. In an exemplary embodiment, a flexible substrate is used. The flexible VPD of the invention can be variously shaped, easily transported, and flexed around non-planar surfaces. The use of z-axis vias allows display elements on a front surface of a substrate to electrically connect with drive circuitry located on a rear surface of the substrate, thereby allowing drive circuitry to be placed anywhere on the rear surface of the substrate, decreasing the electrical circuit density of the front surface, and allowing increased pixel density on the front surface. By partitioning the drive circuitry, very large-scale display panels can be formed while maintaining a desired brightness level.

Exemplary embodiments have been provided herein; however it is noted that the invention can be practiced in other ways that will occur to those skilled in the art. Accordingly, the invention is not limited to the examples presented herein, but is given the broadest scope defined by the following claims.

The above-described and illustrated embodiments of the present invention are examples of implementations set forth for a clear understanding of the principles of the invention. While the invention has been described with reference to particular exemplary embodiments herein, it will be appreciated by those of ordinary skill in the art that modifications can be made to the parts and methods that comprise the invention without departing from the spirit and scope thereof.

What is claimed is:

1. A movie theater display comprising:
an emissive, cinema-sized display panel adapted to produce one or more images, wherein the display panel is flexible.

2. The movie theater display of claim 1, wherein the display panel comprises an electroluminescent display.

3. The movie theater display of claim 2, wherein the display panel comprises one or more nixels.

4. The movie theater display of claim 2, wherein the display panel comprises one or more Sphere-Supported-Thin-Film Electroluminescent (SSTFEL) devices.

5. The movie theater display of claim 1, wherein the display panel comprises a voltage partitioned panel having at least two display subportions, wherein a first subportion is adapted to receive a first voltage from a first subelectrode, and a second subportion is adapted to receive a second voltage from a second subelectrode.

6. The movie theater display of claim 5, wherein the first subportion comprises at least one first display element electrically coupled to the first subelectrode, and wherein the second subportion comprises at least one second display element electrically coupled to the second subelectrode.

7. The movie theatre display of claim 6, wherein the at least one first display element and the at least one second display element are aligned in a same row of the display panel.

8. The movie theater display of claim 5, wherein the first or second voltage comprises a scanning voltage.

9. The movie theater display of claim 1, further comprising a Theater Display Interface (TDI) adapted to receive a video input signal.

10. The movie theater display of claim 9, wherein the TDI is adapted to generate a drive signal for the display panel, wherein the display panel is adapted to produce the one or more images based upon the drive signal.

11. The movie theater display of claim 9, wherein the drive signal comprises a data voltage drive signal.

12. The movie theater display of claim 1, wherein the display panel comprises one or more substrate tiles.

13. A movie theater display comprising an emissive, cinema-sized display panel adapted to produce one or more images, wherein the display panel is voltage-partitioned.

14. The movie theater display of claim 13, wherein the display panel comprises:
at least two display subportions and at least two subelectrodes, wherein a first subelectrode is adapted to provide a first voltage to a first subportion of the display panel, and a second subelectrode is adapted to provide a second voltage to a second subportion of said display panel.

15. The movie theater display of claim 14, wherein the first or second voltage comprises a scanning voltage.

16. The movie theater display of claim 14, wherein each display subportion comprises at least one display element.

17. The movie theater display of claim 16, wherein the first subportion includes at least one first display element and the second subportion includes at least one second display element, wherein the at least one first display element and the at least one second display element are aligned in a same row of the display panel.

18. The movie theater display of claim 13, wherein the display panel comprises a flexible display panel.

19. The movie theater display of claim 13, wherein the display panel comprises an electroluminescent display.

20. The movie theater display of claim 19, wherein the display panel comprises one or more nixels.

21. The movie theater display of claim 19, wherein the display panel comprises one or more Sphere-Supported-Thin-Film Electroluminescent (SSTFEL) devices.

22. The movie theater display of claim 13, further comprising a Theater Display Interface (TDI) adapted to receive a video input signal.

23. The movie theater display of claim 22, wherein the TDI is adapted to generate a drive signal for said display panel, wherein the display panel is adapted to produce the one or more images based upon the drive signal.

24. The movie theater display of claim 23, wherein the drive signal comprises a data voltage signal.

25. The movie theater display of claim 13, wherein the display panel comprises a phosphor.

26. The movie theater display of claim 13, wherein the display panel comprises one or more substrate tiles.

27. A movie theater display comprising:
a flexible substrate tile;
a plurality of display elements coupled to the substrate tile and grouped to define at least two display subportions; and
at least two subelectrodes, wherein a first subelectrode is adapted to provide a first voltage to a first display subportion, and a second subelectrode is adapted to provide a second voltage to a second display subportion.

28. The movie theater display of claim 27, wherein the substrate tile comprises a cinema-sized substrate tile.

29. The movie theater display of claim 27, wherein the first and second voltages comprise scanning voltages.

30. The movie theater display of claim 27, wherein each subportion comprises at least one display element.

31. A movie theater comprising:
a room defined by a plurality of walls and having a display panel extending across at least a portion of two of the plurality of adjacent walls, wherein the display panel comprises a flexible emissive display adapted to display a movie.

32. The movie theater of claim 31, wherein said emissive display is an electroluminescent display.

33. The movie theater of claim 31, wherein the display panel is voltage-partitioned to include at least two subportions and at least two subelectrodes, wherein a first subportion is adapted to receive a first voltage from a first subelectrode, and a second subportion is adapted to receive a second voltage from a second subelectrode.

34. The movie theater of claim 33, wherein the first or second voltage comprises a scanning voltage.

35. The movie theater of claim 31, wherein the room is further defined by a ceiling, wherein the display panel further extends across at least a portion of the ceiling.

36. The movie theater of claim 31, wherein the display panel comprises a cinema-sized display panel.

37. A method for displaying a movie comprising:
providing a cinema-sized display panel, wherein the cinema-sized display panel is flexible and voltage-partitioned to include at least two display subportions and at least two subelectrodes, wherein a first subelectrode is adapted to provide a first voltage to a first display subportion and a second subelectrode is adapted to provide a second voltage to a second display subportion;
receiving a video input signal;
generating a drive signal in response to the video input signal; and
displaying one or more images on the cinema-sized display panel, wherein the one or more images are displayed based upon the drive signal.

38. The method of claim 37, further comprising providing a Theater Display Interface (TDI) adapted to receive the video input signal and generate the drive signal for the flexible display panel.

39. A movie display comprising an emissive, cinema-sized display panel, wherein one or more portions of the display panel is curved.

40. The movie display of claim 39, wherein the display panel comprises a voltage-partitioned display having at least two display subportions and two subelectrodes wherein a first subelectrode is adapted to provide a first voltage to a first subportion and a second subelectrode is adapted to provide a second voltage to a second subportion.

41. The movie display of claim 39, wherein the display panel comprises an electroluminescent display panel.

42. The movie display of claim 39, wherein the display panel comprises at least one of a nixel or a Sphere-Supported-Thin-Film Electroluminescent (SSTFEL) device.
